(19) United States
(12) Patent Application Publication
(10) Pub. No.: US 2025/0307215 A1
(43) Pub. Date: Oct. 2, 2025

(54) METHOD AND APPARATUS FOR PROCESSING METADATA OF DISTRIBUTED FILE SYSTEM

(71) Applicants: Beijing Baidu Netcom Science Technology Co., Ltd., Beijing (CN); Baidu.com Times Technology (Beijing) Co., Ltd., Beijing (CN)

(72) Inventors: Biao CAO, Beijing (CN); Jingwei ZHOU, Beijing (CN); Zhihui YIN, Beijing (CN); Liguo DUAN, Beijing (CN); Ran ZHENG, Beijing (CN)

(21) Appl. No.: 19/238,163

(22) Filed: Jun. 13, 2025

(30) Foreign Application Priority Data
Dec. 20, 2024 (CN) 202411896174.0

(51) Int. Cl. G06F 16/182

(52) U.S. Cl. CPC G06F 16/182

(57) ABSTRACT

A method and an apparatus for processing metadata of a distributed file system are provided. An implementation of the method includes: in response to an amount of metadata of a distributed file system being less than a preset threshold, storing a metadata storage layer table and a path resolution acceleration layer table of the distributed file system on a given original shard; in response to the amount of metadata of the distributed file system being not less than the preset threshold, splitting the original shard into a metadata storage layer shard and a path resolution acceleration layer shard, where the metadata storage layer shard is used to store the metadata storage layer table, and the path resolution acceleration layer shard is used to store the path resolution acceleration layer table; and scheduling the metadata storage layer table on the metadata storage layer shard to different data shards.

### CROSS-REFERENCE TO RELATED APPLICATIONS

This application claims the priority from Chinese Patent Application No. 202411896174.0, filed on Dec. 20, 2024, and titled “METHOD AND APPARATUS FOR PROCESSING METADATA OF DISTRIBUTED FILE SYSTEM,” the entire disclosure of which is hereby incorporated by reference.

### TECHNICAL FIELD

The present disclosure relates to the technical field of artificial intelligence, and more particularly, to the technical field of cloud computing, cloud storage, and cloud database, which can be applied in an intelligent cloud scenario.

### BACKGROUND

The data in the distributed file system may include file data, which may include file content. In addition, the data in the distributed file system may also include metadata. The metadata may include all data of a namespace of the distributed file system, such as a directory, a directory attribute, a file attribute, and the like.

In actual use, the metadata in the distributed file system needs to be processed. However, existing distributed file systems are either excellent in performance at small amounts of data but poor in scalability, or strong in scalability at large amounts of data but poor in performance in small amounts of data processing.

### SUMMARY

Embodiments of the present disclosure provide a method for processing metadata of a distributed file system, a device and a storage medium.

According to a first aspect, an embodiment of the present disclosure provides a method for processing metadata of a distributed file system, including: storing a metadata storage layer table and a path resolution acceleration layer table of the distributed file system on a given original shard, in response to an amount of metadata of the distributed file system being less than a preset threshold, where the metadata storage layer table is used for storing the metadata of the distributed file system, and the path resolution acceleration layer table is used for storing a path of the metadata of the distributed file system; splitting the original shard into a metadata storage layer shard and a path resolution acceleration layer shard in response to the amount of the metadata of the distributed file system being not less than the preset threshold, where the metadata storage layer shard is used for storing the metadata storage layer table, and the path resolution acceleration layer shard is used for storing the path resolution acceleration layer table; and scheduling the metadata storage layer table on the metadata storage layer shard to different data shards.

According to a second aspect, an embodiment of the present disclosure provides an electronic device including at least one processor; and a memory in communication with the at least one processor; where the memory stores instructions executable by the at least one processor, the instructions being executed by the at least one processor to cause the at least one processor to perform the method as described in the first aspect.

According to a third aspect, an embodiment of the present disclosure provides a non-transitory computer-readable storage medium storing computer instructions for causing a computer to perform a method as described in the first aspect.

The key or critical features of the embodiments of the disclosure are also not intended to limit the scope of the disclosure. Other features of the present disclosure will become readily apparent from the following description.

### BRIEF DESCRIPTION OF THE DRAWINGS

Other features, objects, and advantages of the present disclosure will become more apparent by reading the following detailed description of non-limiting embodiments made with reference to the accompanying drawings. The drawings are for a better understanding of the present disclosure and do not constitute a limitation of the present disclosure.

FIG. 1 is a flowchart of a method for processing metadata of a distributed file system according to an embodiment of the present disclosure;

FIG. 2 is a schematic diagram of a single-point metadata architecture;

FIG. 3 is a schematic diagram of a sub-tree partitioning metadata architecture;

FIG. 4 is a schematic diagram of an architecture of metadata fusing a directory partitioning and subtree partitioning;

FIG. 5 is a flowchart of a method for processing metadata of a distributed file system according to yet another embodiment of the present disclosure;

FIG. 6 is a schematic diagram of an original table;

FIG. 7 is a schematic diagram of splitting of an original table;

FIG. 8 is a schematic structural diagram of an apparatus for processing metadata of a distributed file system according to an embodiment of the present disclosure;

FIG. 9 is a block diagram of an electronic device for implementing a method for processing metadata of a distributed file system according to an embodiment of the present disclosure.

### DETAILED DESCRIPTION OF EMBODIMENTS

The following description of exemplary embodiments of the present disclosure, taken in conjunction with the accompanying drawings, includes various details of embodiments of the present disclosure to facilitate understanding, and is to be considered as exemplary only. Accordingly, one of ordinary skill in the art will recognize that various changes and modifications may be made to the embodiments described herein without departing from the scope and spirit of the disclosure. Also, for clarity and conciseness, descriptions of well-known functions and structures are omitted from the following description.

It is noted that the embodiments in the present disclosure and the features in the embodiments may be combined with each other without conflict. The present disclosure will now be described in detail with reference to the accompanying drawings and examples.

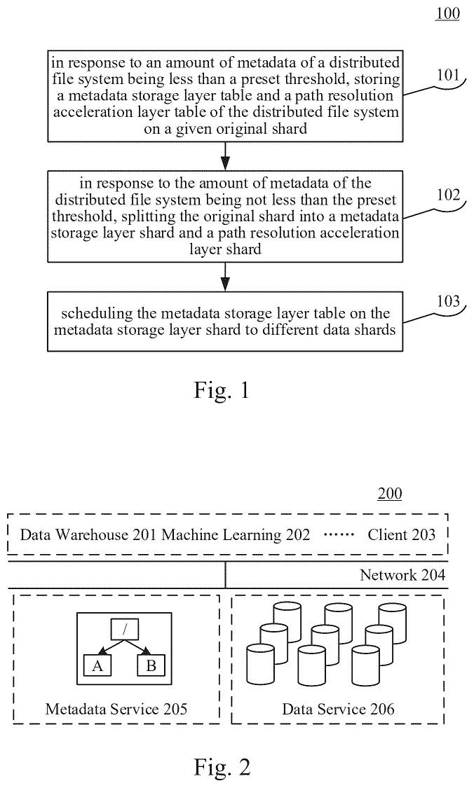

FIG. 1 illustrates a flow 100 of a method for processing metadata of a distributed file system according to an embodiment of the present disclosure. The method for processing metadata of a distributed file system includes the following steps.

Step 101 includes: storing a metadata storage layer table and a path resolution acceleration layer table of the distributed file system on a given original shard, in response to an amount of metadata of a distributed file system being less than a preset threshold.

In the present embodiment, in a small data scale scenario, the amount of the metadata of the distributed file system is less than a preset threshold. In this case, the execution body of the method for processing metadata of a distributed file system may store the metadata storage layer (Dentry) table and the path resolution acceleration layer (Dtree) table of the distributed file system on the given original shard.

The execution body of the method for processing metadata of the distributed file system is generally a server. The server may be hardware or software. When the server is hardware, a distributed server cluster composed of multiple servers may be implemented, or a single server may be implemented. When the server is software, it may be implemented as a plurality of software pieces or software modules (e.g., for providing distributed services), or it may be implemented as a single software piece or software module, which is not specifically limited herein.

A distributed file system refers to a file system where the physical storage resources managed by the file system are not necessarily directly connected to the local node, but are connected to the node through a computer network; or a complete hierarchical file system formed by combining several different logical disk partitions or volume labels. The distributed file system provides a logical tree-structured file system for resources located anywhere on the network, thereby making it more convenient for users to access shared files distributed across the network.

The metadata in the distributed file system may include all data of a namespace of the distributed file system, such as a directory, a directory attribute, a file attribute, and the like.

In small data scale scenarios, the number of files in a distributed file system is relatively small (not exceeding hundreds of millions), and a single-point metadata service can fully meet the requirements. In this case, the metadata storage layer table and the path resolution acceleration layer table of the distributed file system may be stored on a given original shard.

The metadata storage layer table may be used to store the metadata of the distributed file system, such that the hierarchical namespace may be stored and distributed in the metadata storage layer table in the distributed database. The metadata storage layer table stores all the data of the namespace of the distributed file system, including directories, directory attributes, file attributes, and so on. Since the amount of metadata of the distributed file system is less than a preset threshold, the metadata storage layer table is not split and is stored entirely in a single original shard.

The path resolution acceleration layer table may be used to store the paths of the metadata of the distributed file system. To reduce the number of RPC (Remote Procedure Call) performed during path searching, the path resolution acceleration layer table is introduced. The path resolution acceleration layer table is a table in the database, and additionally stores directory information of a hierarchical namespace. In the path resolution acceleration layer table, each record contains only the information necessary to perform the path searching, thereby ensuring that even with a hierarchical namespace of billions of entries, the size of the path resolution acceleration layer table does not exceed 100 GB. Therefore, the path resolution acceleration layer table may be stored entirely in a single original shard without any partitioning, thereby allowing the searching request to resolve long paths by using a single RPC call to the path resolution acceleration layer table.

In addition, to ensure the high availability of the system, all data changes are first written into the WAL (Write-Ahead Logging) and then replicated in the corresponding Raft group. Since there is no range scan requirement for the path resolution acceleration layer table and the amount of data can be stored in full memory, a full memory Hash engine is used. As a storage shard, the path resolution acceleration layer table implements complex operations at the file system level through the UDF in (User-Defined Function). These operations may be integrated into the path resolution acceleration layer table as plugins after being defined by the upper-layer application.

FIG. 2 shows a schematic diagram of a single-point metadata architecture. As shown in FIG. 2, the distributed file system 200 of the single-point metadata architecture may include data warehouse 201, machine learning 202, client 203, network 204, metadata service 205, and data service 206. Here, the data service 206 may be used to store file data in the distributed file system 200. The metadata service 205 may be used to store metadata in the distributed file system 200. The metadata of the distributed file system 200 is stored on a given shard. The root node is empty, the child node A and the child node B of the root node are used to store the metadata of the distributed file system 200, and the root node, the child node A and the child node B are on a given shard.

In some embodiments, in small-scale scenarios, a single-point metadata architecture may be employed to store the metadata storage layer table and the path resolution acceleration layer table on a given original shard. In this case, for a received request of processing the target metadata, the original shard may be searched for the path acceleration layer table to determine the target path. Based on the target path, the original shard may be searched for the metadata storage layer table, and the target metadata may be processed at the found location. The processing may include, but is not limited to, writing, modifying, deleting, and the like. Taking a write operation as an example, since the metadata storage layer table and the path resolution acceleration layer table are stored on the given original shard, the location of the target metadata on the original shard may be queried by only one PRC call, and the target metadata may be written to the original shard by a single write operation, thereby improving performance in a small-scale scenario.

Step 102 includes in response to the amount of metadata of the distributed file system being not less than the preset threshold, splitting the original shard into a metadata storage layer shard and a path resolution acceleration layer shard.

In the present embodiment, as the data size increases, the amount of data of the metadata of the distributed file system is not less than the preset threshold value, a single machine is unable to store the metadata storage layer table and the path resolution acceleration layer table at the same time. In this case, the execution body may split the original shard into a metadata storage layer shard and the path resolution acceleration layer shard.

The metadata storage layer shard may be used to store the metadata storage layer table. The path resolution acceleration layer shard may be used to store the path resolution acceleration layer table. By introducing a full-path index shard for each file system, it is possible to maintain all directory information on a single server, thereby optimizing the file path resolution process and improving efficiency.

Step 103 includes: scheduling the metadata storage layer table on the metadata storage layer shard to different data shards.

In the present embodiment, as the size of the data increases further, the execution body may further split the metadata storage layer shards to schedule the metadata storage layer table to different data shards. In addition, these data shards may continue to be split to carry a larger data scale.

When splitting the metadata storage layer shards, records with a given parent node field may be restricted to a given shard, thereby ensuring that files, directories, and parent directory attributes within a given directory are stored on a given shard. This confines file operations to a single table, thereby enhancing the efficiency of related operations. Not only does the partitioning technology support the scalability of the hierarchical namespace, but the consistency of metadata is also ensured through database services, and the reliability of the system is enhanced through data replication mechanisms. Since the metadata storage layer table needs to support range scans, an LSM-tree type single-machine storage engine may be adopted.

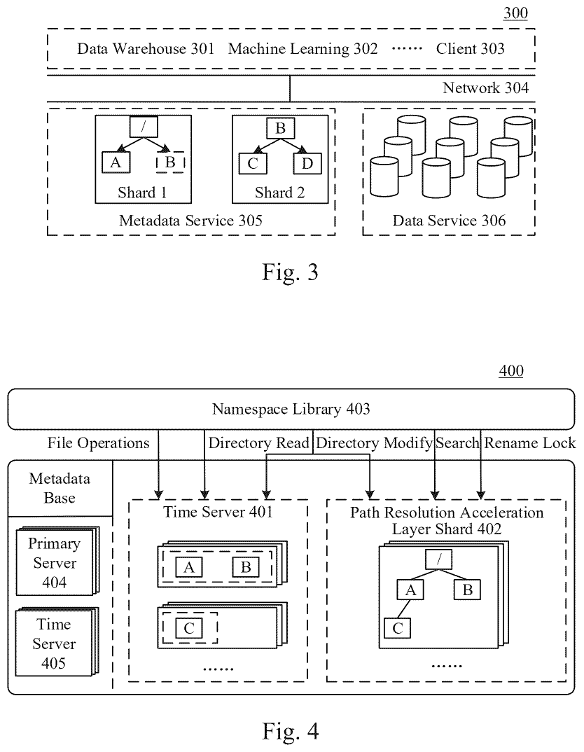

FIG. 3 shows a schematic diagram of a sub-tree partitioning metadata architecture. As shown in FIG. 3, the distributed file system 300 of the sub-tree partitioning metadata architecture may include data warehouse 301, machine learning 302, client 303, network 304, metadata service 305, and data service 306. Here, the data service 306 may be used to store file data in the distributed file system 300. The metadata service 305 may be used to store metadata in the distributed file system 300. The metadata of the distributed file system 300 may be partitioned in a subtree to distribute the metadata in the distributed file system 300 to different nodes, which can roughly evenly scatter the metadata in terms of data volume. The root node is empty, and the root node and the child node A of the root node are on the shard 1. The child node B of the root node, the child node C of the child node B, and the child node D are on the shard 2.

The distributed file system of the directory partitioning metadata architecture may introduce the combination of the distributed file system and the database technology into the metadata field of the distributed file system, and the metadata service is structurally divided into two layers: a database layer and a metadata proxy layer. Here, the database layer may be responsible for data storage, and a NewSQL is generally used to provide a distributed capability while implementing persistence of data, and metadata is scattered to multiple shards of the database system according to a directory. The metadata proxy layer may provide a POSIX or HDFS interface to the outside, convert the data of the hierarchical namespace into a record in the table system, and ensure the correctness of the operation by using a transaction during processing.

FIG. 4 shows a schematic diagram of an architecture of metadata fusing a directory partitioning and subtree partitioning. As shown in FIG. 4, the distributed file system 400 may include a metadata storage layer shard 401, a path resolution acceleration layer shard 402, a namespace library 403, a primary server 404, and a time server 405. The metadata storage layer shard 401 may be used to store a metadata storage layer table. The path resolution acceleration layer shard 402 may be used to store a path resolution acceleration layer table. The metadata of the distributed file system 400 is stored in a metadata storage layer table. The path of the metadata of the distributed file system 400 is stored in the path resolution acceleration layer table. When the metadata storage layer shard 401 is split, records with a given parent node field may be restricted to a given shard. Specifically, the root node is empty, and the child node A and the child node B of the root node are on one shard. Child node C and child node D of node A are on one shard. The path resolution acceleration layer table is on a single shard, used to record the paths of nodes A, B, C, and D. Namespace library 403 may implement directory tree semantic-related logic including, but not limited to, file operations, directory reads, directory modifications, directory statistics, searching, and rename locks. Taking the directory statistics operation as an example, the namespace library first queries the parent path node identifier through an RPC call to the path resolution acceleration layer shard 402, and then queries the directory attribute information through another RPC call to the metadata storage layer shard 401.

In some embodiments, as data scales grow, a distributed architecture may be employed to split the original shard into the metadata storage layer shard and the path resolution acceleration layer shard. The metadata storage layer table is stored on the metadata storage layer shard, the path resolution acceleration layer table is stored on the path resolution acceleration layer shard, which are further scheduled across different data shards. In this case, for a received processing request of the target metadata, the path resolution acceleration layer table on the path resolution acceleration layer shard may be searched to determine the target path. Based on the target path, the metadata storage layer table on the metadata storage layer shard is searched, and the target metadata is processed at the found position. The path resolution acceleration layer table is completely stored on the path resolution acceleration layer shard, allowing the target path to be found with a single RPC call to the path resolution acceleration layer shard, thereby reducing the number of RPC calls made during the path searching process.

For example, the processing request is a write request, and the target path is the path of the parent node of the target metadata. In this case, based on the path of the parent node of the target metadata, the metadata storage layer table may be searched to determine the parent node of the target metadata. A child node is created for the parent node of the target metadata, and the target metadata is written into the child node, and the path of the target metadata is updated into the path resolution acceleration layer table. Since the metadata storage layer table and the path resolution acceleration layer table are stored on different shards, the path resolution acceleration layer shard is first invoked through an RPC call to query the path of the parent node of the target metadata, and then the metadata storage layer shard is invoked through another RPC call to query the parent node of the target metadata. After that, the target metadata is written into the metadata storage layer shard through a single write operation, and the path of the target metadata is written into the path resolution acceleration layer shard through another single write operation.

For example, the processing request is a non-write request, and the target path is a path of the target metadata. In this case, the node of the target metadata may be determined by searching the metadata storage layer table based on the path of the target metadata. The target metadata is processed at the node of the target metadata. The processing may include, but is not limited to, modifying, deleting, and the like. Since the metadata storage layer table and the path resolution acceleration layer table are stored on different shards, the path resolution acceleration layer shard is first invoked through an RPC call to query the path of the target metadata node, and then the metadata storage layer shard is invoked through another RPC call to query the target metadata.

The embodiments of this disclosure provide a distributed file system hierarchical namespace solution with an integrated single-machine and distributed architecture, offering seamless scalability from small to large scales. It can initially operate in a single-machine mode to achieve extremely low latency and then smoothly transition to an efficient distributed mode as services grows. For the single-machine mode, in small-scale scenarios, it can utilize a single-machine namespace system to place the metadata of a user file system entirely in one shard, achieving low latency at the hundred-microsecond level, thereby optimizing performance. For the distributed mode, as the service scale expands and reaches a size that a single machine cannot accommodate, it can seamlessly migrate to a distributed architecture to achieve horizontal scaling and meet the growing processing demands.

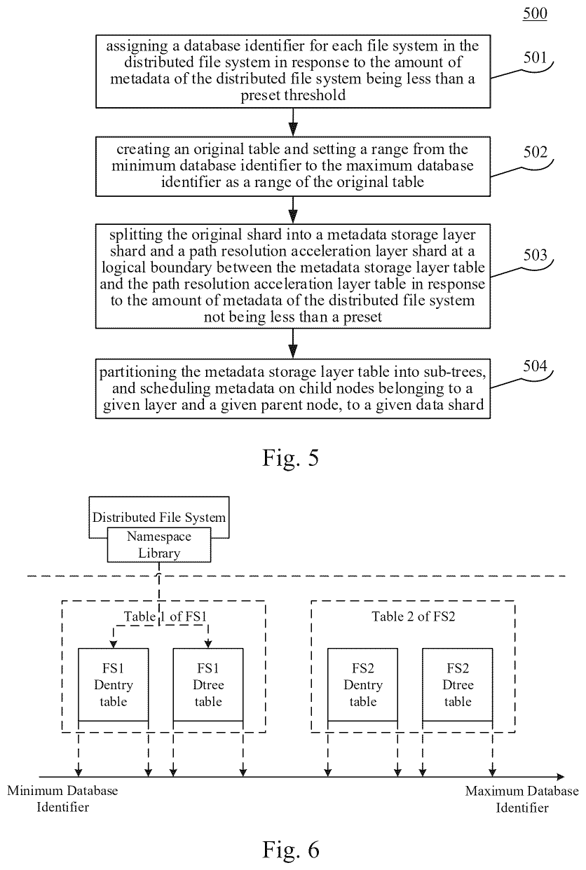

With continuing reference to FIG. 5, a flow 500 of a method for processing metadata of a distributed file system according to yet another embodiment of the present disclosure is illustrated. The method for processing metadata of the distributed file system includes the following steps.

Step 501 includes assigning a database identifier for each file system in the distributed file system in response to the amount of metadata of the distributed file system being less than a preset threshold.

In the present embodiment, in a small data scale scenario, the amount of data of the metadata of the distributed file system is less than a preset threshold value. In this case, the execution body of the method for processing the metadata of the distributed file system may allocate a database identifier (db_id) to each file system in the distributed file system.

The execution body of the method for processing the metadata of the distributed file system is generally a server. The server may be hardware or software. When the server is hardware, a distributed server cluster composed of multiple servers may be implemented, or a single server may be implemented. When the server is software, it may be implemented as a plurality of software pieces or software modules (e.g., for providing distributed services), or it may be implemented as a single software piece or software module, which is not specifically limited herein.

The distributed file system refers to a file system where the physical storage resources managed by the file system are not necessarily directly connected to the local node, but are connected to the node through a computer network; or a complete hierarchical file system formed by combining several different logical disk partitions or volume labels. The distributed file system provides a logical tree file system structure for resources distributed anywhere on the network, thereby making it more convenient for users to access shared files distributed on the network.

By assigning a unique database identifier to each file system in the distributed file system, a logically isolated environment can be created for each file system. Each file system may include a metadata storage layer table and a path resolution acceleration layer table, thereby ensuring that the data of these two tables are within a given ordered encoding space so that they can be stored in the given original shard.

Step 502 includes creating an original table and setting a range from the minimum database identifier to the maximum database identifier as a range of the original table.

In the present embodiment, at the time of creating the database, the execution body may create an original table (Table) and set a range from the minimum database identifier (db_id_MIN) to the maximum database identifier (db_id_MAX) as the range of the original table.

The metadata storage layer table and the path resolution acceleration layer table belonging to the file system of a given original table are stored on a given original shard. Setting the range of the original table to a key range ([db_id_MIN, db_id_MAX]) ensures that this range is sufficient to cover the data of the entire distributed file system so that all the data of the metadata storage layer table and the path resolution acceleration layer table fall within this original shard.

FIG. 6 shows a schematic diagram of the original table. As shown in FIG. 6, Table 1 of the distributed file system FS1 includes a FS1 Dentry table and a FS1 Dtree table. Table 2 of the distributed file system FS2 includes a FS2 Dentry table and a FS2 Dtree table. An original table is created for the namespace library of the distributed file system and the range of the original table is set from a minimum database identifier to a maximum database identifier, thereby ensuring that all the Dentry tables and the Dtree tables of the distributed file system are in a given shard.

Step 503 includes splitting the original shard into a metadata storage layer shard and a path resolution acceleration layer shard at a logical demarcation point between the metadata storage layer table and the path resolution acceleration layer table in response to the amount of metadata of the distributed file system not being less than a preset threshold.

In the present embodiment, as the data scale increases, the amount of data of the metadata of the distributed file system is not less than a preset threshold value. In this case, a single machine cannot store the metadata storage layer table and the path resolution acceleration layer table at the same time, and the execution body may split the original shard at a logical demarcation point between the metadata storage layer table and the path resolution acceleration layer table to obtain the metadata storage layer shard and the path resolution acceleration layer shard.

The table splitting function of TafDB enables splitting at the logical demarcation point db_id_dentry_MAX of the metadata storage layer table and the path resolution acceleration layer table. The metadata storage layer shard includes a metadata storage layer table with a range of [db_id_MIN, db_id_dentry_MAX). The path resolution acceleration layer shard includes a path resolution acceleration layer table with a range of [db_id_dentry_MAX, db_id_MAX).

Step 504 includes partitioning the metadata storage layer table into sub-trees, and scheduling metadata on child nodes belonging to a given layer and a given parent node, to a given data shard.

In the present embodiment, the execution body may partition the metadata storage layer table into sub-trees, and schedule the metadata on the child nodes belonging to the given layer and the given parent node, to the given data shard.

When the metadata storage shard is split, records with a given parent node field can be restricted to a given shard. This ensures that files, directories, and parent directory attributes within the given directory are stored in the given shard, thereby confining file operations to a single table and enhancing the efficiency of related operations. Not only does the partitioning technology support the expansion of hierarchical namespaces, but database transactions also ensure metadata consistency, and data replication mechanisms enhance system reliability. Since the metadata storage layer table needs to support range scans, an LSM-tree type single-machine storage engine may be employed.

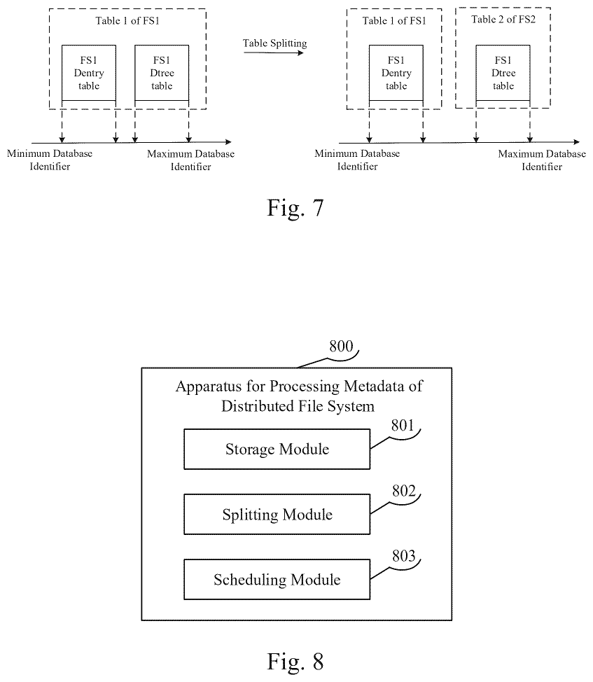

FIG. 7 shows a schematic diagram of the splitting of the original table. As shown in FIG. 7, Table 1 of the distributed file system FS1 may include a FS1 Dentry table and a FS1 Dtree table. The original table is split at the logical demarcation point between the Dentry table and the Dtree table, resulting in the FS1 Dentry table being in one shard and the FS1 Dtree table being in another shard.

The embodiments of the present disclosure provides a distributed file system hierarchical namespace solution with an integrated single-machine and distributed architecture, which has seamless scalability from small to large scales. It can initially operate in a single-machine mode to achieve extremely low latency and then smoothly switch to an efficient distributed mode as services grow. For the single-machine mode, in small-scale scenarios, it can use a single-machine namespace system to place the metadata of a user file system entirely in one shard, achieving low latency at the hundred-microsecond level, thereby optimizing performance. For the distributed mode, as the service scale expands and the size grows beyond the capacity of a single machine, it can seamlessly migrate to a distributed architecture to achieve horizontal scaling and meet the ever-increasing processing demands.

With further reference to FIG. 8, as an implementation of the method shown in each of the above figures, an apparatus for processing metadata of a distributed file system is provided according to an embodiment of the disclosure. The apparatus embodiment corresponds to the method embodiment shown in FIG. 1, and the apparatus can be specifically applied to various electronic devices.

As shown in FIG. 8, the apparatus 800 for processing metadata of the distributed file system of the present embodiment may include a storage module 801, a splitting module 802, and a scheduling module 803. The storage module 801 is configured to store a metadata storage layer table and a path resolution acceleration layer table of the distributed file system on a given original shard, in response to an amount of metadata of a distributed file system being less than a preset threshold, where the metadata storage layer table is used for storing the metadata of the distributed file system, and the path resolution acceleration layer table is used for storing the path of the metadata of the distributed file system; the splitting module 802 is configured to split an original shard into a metadata storage layer shard and a path resolution acceleration layer shard, in response to the amount of data of the metadata of the distributed file system being not less than the preset threshold, where the metadata storage layer shard stores the metadata storage layer table and the path resolution acceleration layer shard stores the path resolution acceleration layer table; and the scheduling module 803 is configured to schedule the metadata storage layer table on the metadata storage layer shard to different data shards.

In the present embodiment, in the apparatus 800 for processing metadata of the distributed file system, the specific processing of the storage module 801, the splitting module 802, and the scheduling module 803 and the technical effects thereof may be described with reference to the related description of step 101-103 in the corresponding embodiment in FIG. 1, and details are not described herein again.

In some alternative implementations of the present embodiment, the storage module 801 is further configured to assign a database identifier to each file system in the distributed file system; create an original table and set a range from the minimum database identifier to the maximum database identifier as a range of the original table, where the metadata storage layer table and the path resolution acceleration layer table of the file system belonging to the given original table are stored on the given original shard.

In some alternative implementations of the present embodiment, the splitting module 802 is further configured to split the original shard at the logical demarcation point between the metadata storage layer table and the path resolution acceleration layer table to obtain the metadata storage layer shard and the path resolution acceleration layer shard, where the metadata storage layer shard ranges from the minimum database identifier to the identifier of the logical demarcation point, and the path resolution acceleration layer shard ranges from the identifier of the logical demarcation point to the maximum database identifier.

In some alternative implementations of the present embodiment, the scheduling module 803 is further configured to partition the metadata storage layer table into sub-trees, and schedule metadata on child nodes belonging to a given layer and a given parent node, to a given data shard.

In some alternative implementations of the present embodiment, the apparatus 800 for processing metadata of the distributed file system further includes a receiving module configured to receive a processing request of the target metadata; a first determining module configured to, in response to the metadata storage layer table and the path resolution acceleration layer table being stored on the given original shard, search the path resolution acceleration layer table on the original shard based on the processing request to determine a target path; and a first processing module configured to search the metadata storage layer table on the original shard based on the target path and process the target metadata at a found location.

In some alternative implementations of the present embodiment, the apparatus 800 for processing metadata of the distributed file system further includes a second determining module configured to determine a target path by searching the path resolution acceleration layer table on the path resolution acceleration layer shard based on the processing request, in response to the metadata storage layer table being stored on the metadata storage layer table and the path resolution acceleration layer table being stored on the path resolution acceleration layer table; and a second processing module configured to search the metadata storage layer table on the metadata storage layer shard based on the target path and process the target metadata at a found location.

In some alternative implementations of the present embodiment, for the apparatus 800 for processing metadata of the distributed file system, a processing request is a write request, and the target path is a path of a parent node of the target metadata; and the second processing module is further configured to search the metadata storage layer table based on the path of the parent node of the target metadata to determine the parent node of the target metadata; create a child node for a parent node of the target metadata, write the target metadata into the child node, and update a path of the target metadata into a path resolution acceleration layer table.

In some alternative implementations of the present embodiment, for the apparatus 800 for processing metadata of the distributed file system, a processing request is a non-write request, and the target path is a path of the target metadata; and the second processing module is further configured to search the metadata storage layer table based on the path of the target metadata to determine a node of the target metadata; and process the target metadata at the node of the target metadata.

In the technical solution of the present disclosure, the acquisition, storage and application of the user personal information are all in accordance with the relevant laws and regulations, and do not violate the public order and good customs.

According to an embodiment of the present disclosure, the present disclosure also provides an electronic device, a readable storage medium, and a computer program product.

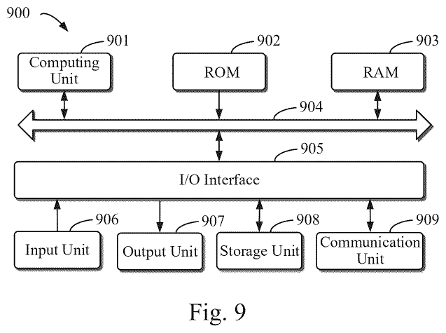

FIG. 9 illustrates a schematic block diagram of an example electronic device 900 that may be used to implement embodiments of the present disclosure. Electronic devices are intended to represent various forms of digital computers, such as laptop computers, desktop computers, worktables, personal digital assistants, servers, blade servers, mainframe computers, and other suitable computers. Electronic devices may also represent various forms of mobile devices, such as personal digital processing, cellular telephones, smart phones, wearable devices, and other similar computing devices. The components shown herein, their connections and relationships, and their functions are by way of example only and are not intended to limit the implementation of the disclosure described and/or claimed herein.

As shown in FIG. 9, the device 900 includes a computing unit 901, which may perform various appropriate actions and processes according to a computer program stored in a read-only memory (ROM) 902 or a computer program loaded into a random access memory (RAM) 903 from a storage unit 908. In RAM 903, various programs and data required for operation of the device 900 may also be stored. The computing unit 901, ROM 902 and RAM 903 are connected to each other via a bus 904. An input/output (I/O) interface 905 is also connected to bus 904.

Multiple components in the device 900 are connected to the I/O interface 905, including an input unit 906, such as a keyboard, a mouse, and the like; an output unit 907, such as various types of displays, speakers, and the like; a storage unit 908, such as a magnetic disk, an optical disk, or the like; and a communication unit 909, such as a network card, a modem, or a wireless communication transceiver. The communication unit 909 allows the device 900 to exchange information/data with other devices over a computer network such as the Internet and/or various telecommunications networks.

The computing unit 901 may be various general and/or special-purpose processing components having processing and computing capabilities. Some examples of computing units 901 include, but are not limited to, central processing units (CPUs), graphics processing units (GPUs), various specialized artificial intelligence (AI) computing chips, various computing units running machine learning model algorithms, digital signal processors (DSPs), and any appropriate processors, controllers, microcontrollers, and the like. The computing unit 901 performs various methods and processes described above, such as a method for processing metadata of a distributed file system. For example, in some embodiments, the method for processing metadata of the distributed file system may be implemented as a computer software program tangibly embodied in a machine-readable medium, such as storage unit 908. In some embodiments, part or all of the computer program may be loaded and/or installed on the device 900 via the ROM 902 and/or the communication unit 909. When the computer program is loaded to the RAM 903 and executed by the computing unit 901, one or more steps of the method for processing metadata of the distributed file system described above may be performed. Alternatively, in other embodiments, the computing unit 901 may be configured to perform the method for processing metadata of the distributed file system in any other appropriate manner (e.g., via firmware).

The various embodiments of the systems and techniques described above herein may be implemented in a digital electronic circuit system, an integrated circuit system, a field programmable gate array (FPGA), an application specific integrated circuit (ASIC), a special purpose standard product (ASSP), a system on a system on a chip (SOC), a load programmable logic device (CPLD), computer hardware, firmware, software, and/or combinations thereof. These various embodiments may include being implemented in one or more computer programs that may be executed and/or interpreted on a programmable system including at least one programmable processor, which may be a dedicated or general programmable processor, may receive data and instructions from a storage system, at least one input device, and at least one output device, and transmit the data and instructions to the storage system, the at least one input device, and the at least one output device.

The program code for carrying out the methods of the present disclosure may be written in any combination of one or more programming languages. These program codes may be provided to a processor or controller of a general computer, special purpose computer, or other programmable data processing apparatus such that the program code, when executed by the processor or controller, causes the functions/operations specified in the flowchart and/or block diagram to be implemented. The program code may be executed entirely on the machine, partly on the machine, partly on the machine as a stand-alone software package and partly on the remote machine or entirely on the remote machine or server.

In the context of the present disclosure, a machine-readable medium may be a tangible medium that may contain or store a program for use by or in connection with an instruction execution system, apparatus, or device. The machine-readable medium may be a machine-readable signal medium or a machine-readable storage medium. The machine-readable medium may include, but is not limited to, electronic, magnetic, optical, electromagnetic, infrared, or semiconductor systems, devices, or devices, or any suitable combination of the foregoing. More specific examples of machine-readable storage media may include one or more line-based electrical connections, portable computer disks, hard disks, random access memory (RAM), read-only memory (ROM), erasable programmable read-only memory (EPROM or flash memory), optical fibers, portable compact disk read-only memory (CD-ROM), optical storage devices, magnetic storage devices, or any suitable combination of the foregoing.

To provide interaction with a user, the systems and techniques described herein may be implemented on a computer having a display device (e.g., a CRT (cathode ray tube) or LCD (liquid crystal display) monitor) for displaying information to the user; and a keyboard and a pointing device (e.g., a mouse or a trackball) through which a user can provide input to a computer. Other types of devices may also be used to provide interaction with a user; for example, the feedback provided to the user may be any form of sensory feedback (e.g., visual feedback, auditory feedback, or tactile feedback); and input from the user may be received in any form, including acoustic input, speech input, or tactile input.

The systems and techniques described herein may be implemented in a computing system including a background component (e.g., as a data server), or a computing system including a middleware component (e.g., an application server), or a computing system including a front-end component (e.g., a user computer having a graphical user interface or a web browser through which a user may interact with embodiments of the systems and techniques described herein), or a computing system including any combination of such background component, middleware component, or front-end component. The components of the system may be interconnected by any form or medium of digital data communication (e.g., a communication network). Examples of communication networks include a local area network (LAN), a wide area network (WAN), and the Internet.

The computer system may include a client and a server. The client and server are typically remote from each other and typically interact through a communication network. The relationship between the client and the server is generated by a computer program running on the corresponding computer and having a client-server relationship with each other. The server may be a cloud server, a server of a distributed system, or a server incorporating a chain of blocks.

It is to be understood that the steps of reordering, adding or deleting may be performed using the various forms shown above. For example, the steps described in the present disclosure may be performed in parallel or sequentially or in a different order, so long as the desired results of the technical solution provided in the present disclosure can be realized, and no limitation is imposed herein.

The foregoing detailed description is not intended to limit the scope of the present disclosure. It will be appreciated by those skilled in the art that various modifications, combinations, sub-combinations, and substitutions may be made depending on design requirements and other factors. Any modifications, equivalents, and modifications that fall within the spirit and principles of the disclosure are intended to be included within the scope of protection of the disclosure.

What is claimed is:

1. A method for processing metadata of a distributed file system, the method comprising:
storing a metadata storage layer table and a path resolution acceleration layer table of the distributed file system on a given original shard, in response to an amount of metadata of the distributed file system being less than a preset threshold, wherein the metadata storage layer table is used for storing the metadata of the distributed file system, and the path resolution acceleration layer table is used for storing a path of the metadata of the distributed file system;
splitting the original shard into a metadata storage layer shard and a path resolution acceleration layer shard, in response to the amount of the metadata of the distributed file system being not less than the preset threshold, wherein the metadata storage layer shard is used for storing the metadata storage layer table, and the path resolution acceleration layer shard is used for storing the path resolution acceleration layer table; and
scheduling the metadata storage layer table on the metadata storage layer shard to different data shards.

2. The method according to claim 1, wherein the storing the metadata storage layer table and the path resolution acceleration layer table of the distributed file system on the given original shard comprises:
assigning a database identifier to each file system in the distributed file system; and
creating an original table, and setting a range from the minimum database identifier to the maximum database identifier as a range of the original table, wherein a metadata storage layer table and a path resolution acceleration layer table of the distributed file system, belonging the given original table, are stored on the given original shard.

3. The method according to claim 2, wherein the splitting the original shard into the metadata storage layer shard and the path resolution acceleration layer shard comprises:
splitting the original shard at a logical demarcation point between the metadata storage layer table and the path resolution acceleration layer table to obtain the metadata storage layer shard and the path resolution acceleration layer shard, wherein the metadata storage layer shard ranges from the minimum database identifier to an identifier of the logical demarcation point, and the path resolution acceleration layer shard ranges from the identifier of the logical demarcation point to the maximum database identifier.

4. The method according to claim 1, wherein the scheduling the metadata storage layer table on the metadata storage layer shard to different data shards comprises:
partitioning the metadata storage layer table into sub-trees, and scheduling metadata on child nodes belonging to a given layer and a given parent node, to a given data shard.

5. The method according to claim 1, wherein the method further comprises:
receiving a processing request for target metadata;
in response to the metadata storage layer table and the path resolution acceleration layer table being stored on the given original shard, searching the path resolution acceleration layer table on the original shard based on the processing request to determine a target path; and
searching the metadata storage layer table on the original shard based on the target path, and processing the target metadata at a found location.

6. The method according to claim 5, wherein the method further comprises:
searching the path resolution acceleration layer table on the path resolution acceleration layer shard to determine the target path based on the processing request, in response to the metadata storage layer table being stored on the metadata storage layer table and the path resolution acceleration layer table being stored on the path resolution acceleration layer table; and
searching the metadata storage layer table on the metadata storage layer shard based on the target path, and processing the target metadata at the found location.

7. The method according to claim 6, wherein the processing request is a write request and the target path is a path of a parent node of the target metadata; and
the searching the metadata storage layer table on the metadata storage layer shard based on the target path, and processing the target metadata at the found location includes:
searching the metadata storage layer table based on the path of the parent node of the target metadata to determine the parent node of the target metadata; and
creating a child node for a parent node of the target metadata, writing the target metadata to the child node, and updating a path of the target metadata into the path resolution acceleration layer table.

8. The method according to claim 7, wherein the processing request is a non-write request and the target path is a path of the target metadata; and
the searching the metadata storage layer table on the metadata storage layer shard based on the target path, and processing the target metadata at the found location comprises:
searching the metadata storage layer table based on the path of the target metadata to determine a node of the target metadata; and
processing the target metadata on the node of the target metadata.

9. An electronic device comprising:
at least one processor; and
a memory in communication with the at least one processor;
wherein the memory stores instructions executable by the at least one processor to cause the at least one processor to perform operations comprising:
storing a metadata storage layer table and a path resolution acceleration layer table of the distributed file system on a given original shard, in response to an amount of metadata of the distributed file system being less than a preset threshold, wherein the metadata storage layer table is used for storing the metadata of the distributed file system, and the path resolution acceleration layer table is used for storing a path of the metadata of the distributed file system;
splitting the original shard into a metadata storage layer shard and a path resolution acceleration layer shard, in response to the amount of the metadata of the distributed file system being not less than the preset threshold, wherein the metadata storage layer shard is used for storing the metadata storage layer table, and the path resolution acceleration layer shard is used for storing the path resolution acceleration layer table; and
scheduling the metadata storage layer table on the metadata storage layer shard to different data shards.

10. The device according to claim 9, wherein the storing the metadata storage layer table and the path resolution acceleration layer table of the distributed file system on the given original shard comprises:
assigning a database identifier to each file system in the distributed file system; and
creating an original table, and setting a range from the minimum database identifier to the maximum database identifier as a range of the original table, wherein a metadata storage layer table and a path resolution acceleration layer table of the distributed file system, belonging the given original table, are stored on the given original shard.

11. The device according to claim 10, wherein the splitting the original shard into the metadata storage layer shard and the path resolution acceleration layer shard comprises:
splitting the original shard at a logical demarcation point between the metadata storage layer table and the path resolution acceleration layer table to obtain the metadata storage layer shard and the path resolution acceleration layer shard, wherein the metadata storage layer shard ranges from the minimum database identifier to an identifier of the logical demarcation point, and the path resolution acceleration layer shard ranges from the identifier of the logical demarcation point to the maximum database identifier.

12. The device according to claim 9, wherein the scheduling the metadata storage layer table on the metadata storage layer shard to different data shards comprises:
partitioning the metadata storage layer table into sub-trees, and scheduling metadata on child nodes belonging to a given layer and a given parent node, to a given data shard.

13. The device according to claim 9, wherein the operations further comprise:
receiving a processing request for target metadata;
in response to the metadata storage layer table and the path resolution acceleration layer table being stored on the given original shard, searching the path resolution acceleration layer table on the original shard based on the processing request to determine a target path; and
searching the metadata storage layer table on the original shard based on the target path, and processing the target metadata at a found location.

14. The device according to claim 13, wherein the operations further comprise:
searching the path resolution acceleration layer table on the path resolution acceleration layer shard to determine the target path based on the processing request, in response to the metadata storage layer table being stored on the metadata storage layer table and the path resolution acceleration layer table being stored on the path resolution acceleration layer table; and
searching the metadata storage layer table on the metadata storage layer shard based on the target path, and processing the target metadata at the found location.

15. The device according to claim 14, wherein the processing request is a write request and the target path is a path of a parent node of the target metadata; and
the searching the metadata storage layer table on the metadata storage layer shard based on the target path, and processing the target metadata at the found location includes:
searching the metadata storage layer table based on the path of the parent node of the target metadata to determine the parent node of the target metadata; and
creating a child node for a parent node of the target metadata, writing the target metadata to the child node, and updating a path of the target metadata into the path resolution acceleration layer table.

16. The device according to claim 15, wherein the processing request is a non-write request and the target path is a path of the target metadata; and
the searching the metadata storage layer table on the metadata storage layer shard based on the target path, and processing the target metadata at the found location comprises:
searching the metadata storage layer table based on the path of the target metadata to determine a node of the target metadata; and
processing the target metadata on the node of the target metadata.

17. A non-transitory computer-readable storage medium storing computer instructions for causing a computer to perform operations comprising:
storing a metadata storage layer table and a path resolution acceleration layer table of the distributed file system on a given original shard, in response to an amount of metadata of the distributed file system being less than a preset threshold, wherein the metadata storage layer table is used for storing the metadata of the distributed file system, and the path resolution acceleration layer table is used for storing a path of the metadata of the distributed file system;
splitting the original shard into a metadata storage layer shard and a path resolution acceleration layer shard, in response to the amount of the metadata of the distributed file system being not less than the preset threshold, wherein the metadata storage layer shard is used for storing the metadata storage layer table, and the path resolution acceleration layer shard is used for storing the path resolution acceleration layer table; and
scheduling the metadata storage layer table on the metadata storage layer shard to different data shards.

18. The non-transitory computer-readable storage medium according to claim 17, wherein the storing the metadata storage layer table and the path resolution acceleration layer table of the distributed file system on the given original shard comprises:
assigning a database identifier to each file system in the distributed file system; and
creating an original table, and setting a range from the minimum database identifier to the maximum database identifier as a range of the original table, wherein a metadata storage layer table and a path resolution acceleration layer table of the distributed file system, belonging the given original table, are stored on the given original shard.

19. The non-transitory computer-readable storage medium according to claim 18, wherein the splitting the original shard into the metadata storage layer shard and the path resolution acceleration layer shard comprises:
splitting the original shard at a logical demarcation point between the metadata storage layer table and the path resolution acceleration layer table to obtain the metadata storage layer shard and the path resolution acceleration layer shard, wherein the metadata storage layer shard ranges from the minimum database identifier to an identifier of the logical demarcation point, and the path resolution acceleration layer shard ranges from the identifier of the logical demarcation point to the maximum database identifier.

20. The non-transitory computer-readable storage medium according to claim 17, wherein the scheduling the metadata storage layer table on the metadata storage layer shard to different data shards comprises:
partitioning the metadata storage layer table into sub-trees, and scheduling metadata on child nodes belonging to a given layer and a given parent node, to a given data shard.
